(19) United States
(12) Patent Application Publication
(10) Pub. No.: US 2011/0085199 A1
(43) Pub. Date: Apr. 14, 2011

(54) PRINTER AND PRINTING CONTROL METHOD

(75) Inventor: Shinya Nagano, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/874,448

(22) Filed: Sep. 2, 2010

Related U.S. Application Data
(60) Provisional application No. 61/251,038, filed on Oct. 13, 2009.

(51) Int. Cl. G06F 3/12

(52) U.S. Cl. 358/1.15

(57) ABSTRACT

A printer includes an insertion portion on which a first memory having print data stored therein is inserted; and a controller which acquires preset print setting information and performs printing of the print data based on the print setting information. The print setting information may be stored in the first memory. The first memory may be a portable USB memory.

### CROSS-REFERENCE TO RELATED APPLICATIONS

This application is also based upon and claims the benefit of priority from U.S. provisional application 61/251,038, filed on Oct. 13, 2009; the entire contents of which are incorporated herein by reference.

### FIELD

Embodiments described herein relate generally to a technique for printing print data.

### BACKGROUND

A method of printing print data stored in a portable memory through direct insertion of the memory on a printer is known. If print settings of the print data are changed in the printer, the settings require a prolonged period to limit the use of the printer by other users. In a method of performing print setting with a PC located externally to the printer in printing, the setting operation in the printing is complicated.

### DESCRIPTION OF THE DRAWINGS

FIG. 1 is a section view of a printer.

FIG. 2 is a block diagram of the printer and its peripheral equipment.

FIG. 3 is a flow chart showing a method of forming print setting information.

FIG. 4 shows a UI in forming the print setting information.

FIG. 5 shows a UI in forming the print setting information.

FIG. 6 shows a UI in forming the print setting information.

FIG. 7 is a flow chart showing a method of printing print data stored in a portable memory.

FIG. 8 shows a UI in printing.

FIG. 9 shows a UI in printing.

FIG. 10 shows a UI in printing.

### DETAILED DESCRIPTION

In general, one embodiment is provided for a printer which includes an insertion portion is inserted a first memory stores print data, and a controller which acquires preset print setting information and performing printing of the print data based on the print setting information.

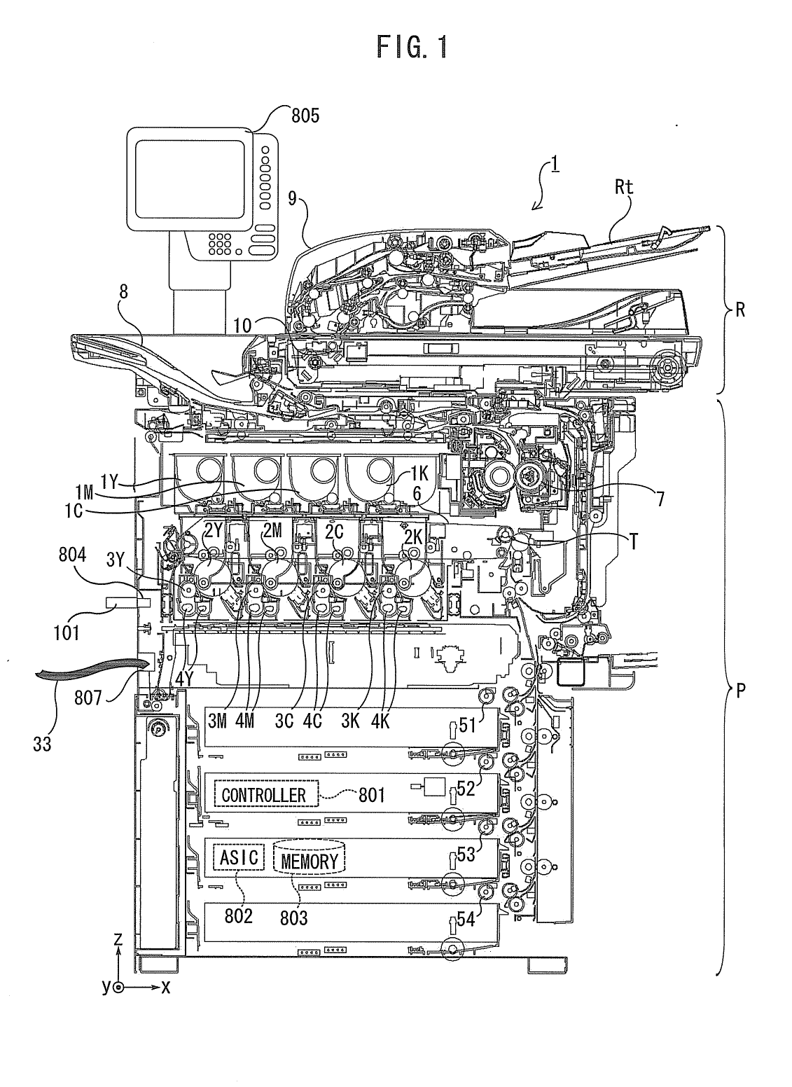

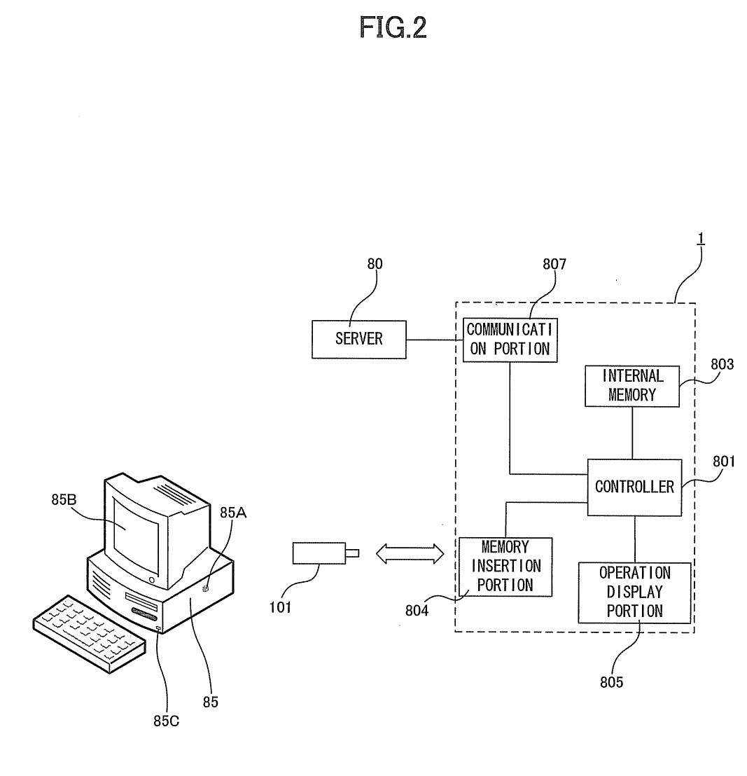

FIG. 1 is a section view of the printer. An X axis, a Y axis, and a Z axis represent three axes which are orthogonal to each other. FIG. 2 is a block diagram showing the printer and its peripheral equipment.

Referring to FIG. 1, the printer 1 includes an image reading portion R and an image forming potion P. The image reading portion R has the function of scanning and reading the images of a sheet document and a book document.

The image forming portion P has the function of forming a developer image on a sheet based on the image read from the document in the image reading portion R, print data transmitted from an external device to the printer 1, or the like.

The image reading portion R includes an ADF (Auto Document Feeder) 9 which can automatically feed the document to a predetermined image reading position, and reads the image of a document placed on a document tray (predetermined document placement stage) Rt automatically fed by the ADF 9 or the image of a document placed on a document stage, not shown, with a scanning optical system 10.

The image forming portion P includes toner cartridges 1Y to 1K, pickup rollers 51 to 54, photosensitive materials 2Y to 2K, development rollers 3Y to 3K, mixers 4Y to 4K, an intermediate transfer belts 6, a fixer 7, and a discharge tray 8.

The printer 1 includes a controller 801, an ASIC circuit 802, an internal memory 803 serving as a second memory, a memory insertion portion 804, an operation display portion 805, and a communication portion 807. The controller 801 is responsible for performing various types of processing in the printer 1 and is also responsible for realizing various functions through execution of programs stored in the internal memory 803. The internal memory 803 may be, for example, RAM (Random Access Memory), ROM (Read Only Memory), DRAM (Dynamic Random Access Memory), SRAM (Static Random Access Memory), or VRAM (Video RAM), and is responsible for storing various types of information and programs used in an image processing apparatus.

The operation display portion 805 displays various settings. Various settings are changed by operating the operation display portion 805. The operation display portion 805 may be of a touch panel type.

A portable memory 101 serving as a first memory is inserted on the memory insertion portion 804. The portable memory 101 may be a USB (Universal Serial Bus) memory. The portable memory 101 has print data and print setting information stored therein. The print setting information may be formed in a PC 85 independent of the printer 1. The print setting information may include at least one of stapling, hole punching, and Nin1. Referring to FIG. 2, the PC 85 includes a PC controller 85A, a display screen 85B, and a PC memory insertion portion 85C.

A LAN cable 33 is connected to the communication portion 807. The communication portion 807 is connected to a server 80 through the LAN cable 33. The controller 801 may download data from the server 80 through the communication portion 807 and the LAN cable 33. The controller 801 may transmit data to the server 80 through the communication portion 807. The server 80 may transmit the data output from the communication portion 807 to an external PC.

Description will hereinafter be made of the outlines of copy processing as an example of processing in the image processing apparatus.

First, a sheet picked up from a cassette by the pickup rollers 51 to 54 is supplied into a sheet feed path. The sheet supplied into the sheet feed path is fed in a predetermined feed direction by a plurality of pairs of rollers.

The image of a plurality of sheet documents automatically fed continuously by the ADF 9 is read at the predetermined image reading position by the scanning optical system 10.

Next, based on the print data of the image read from the document in the image reading portion R, an electrostatic latent image is formed on photosensitive surfaces of the photosensitive materials 2Y, 2M, 2C, and 2K for transferring developer images of yellow (Y), magenta (M), cyan (C), and black (K), respectively, to the sheet.

Then, the developer mixed by the mixers 4Y to 4K in a development device is supplied by the development rollers 3Y to 3K to the photosensitive materials 2Y to 2K on which the electrostatic latent image is formed as described above. This visualizes the electrostatic latent image formed on the photosensitive surfaces of the photosensitive materials.

The developer image formed on the photosensitive materials in this manner is transferred onto a belt surface of the intermediate transfer belt 6 (so-called primary transfer), and the developer image fed through the rotation of the intermediate transfer belt is transferred onto the fed sheet at a predetermined secondary transfer position T.

The developer image transferred onto the sheet is heated and fixed to the sheet by the fixer 7. The sheet having the developer image heated and fixed thereto is fed in the feed path by a plurality of pairs of feed rollers and is sequentially discharged onto the discharge tray 8.

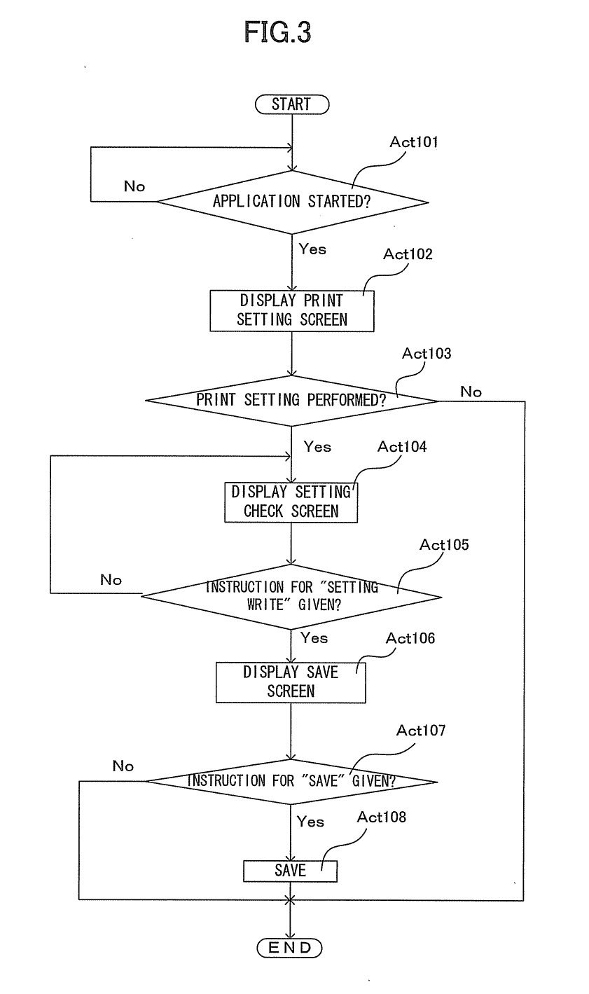

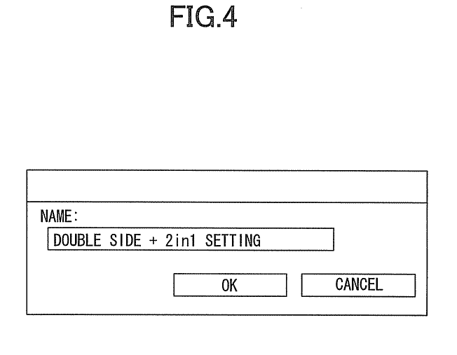

Next, a method of forming the print setting information will be described with reference to FIG. 3 to FIG. 6. FIG. 3 is a flow chart showing the method of print setting. The print setting may be performed in the PC 85. FIG. 4 to FIG. 6 show UIs (User Interface) of the PC 85 in performing the print setting.

At Act 101, the PC controller 85A determines whether or not an application for performing the print setting is started. If the application is started at Act 101, the controller 85A proceeds to Act 102. At Act 102, the PC controller 85A displays a print setting screen shown in FIG. 4 on the display screen 85B of the PC 85. The name of a desired print setting is entered into a “name” field displayed on the display screen 85B. The name of the print setting, “double side+2in1,” is entered. Alternatively, a plurality of print settings different from each other may be displayed on the display screen 85B and some of these print settings may be selected or combined to suit the preferences of the user.

At Act 103, the PC controller 85A determines whether or not the print setting is performed. If “OK” is selected on the display screen 85B in FIG. 4, the PC controller 85A determines that the print setting is performed, and proceeds to Act 104. If “cancel” is selected, the PC controller 85A determines that the printing is stopped, and ends the flow.

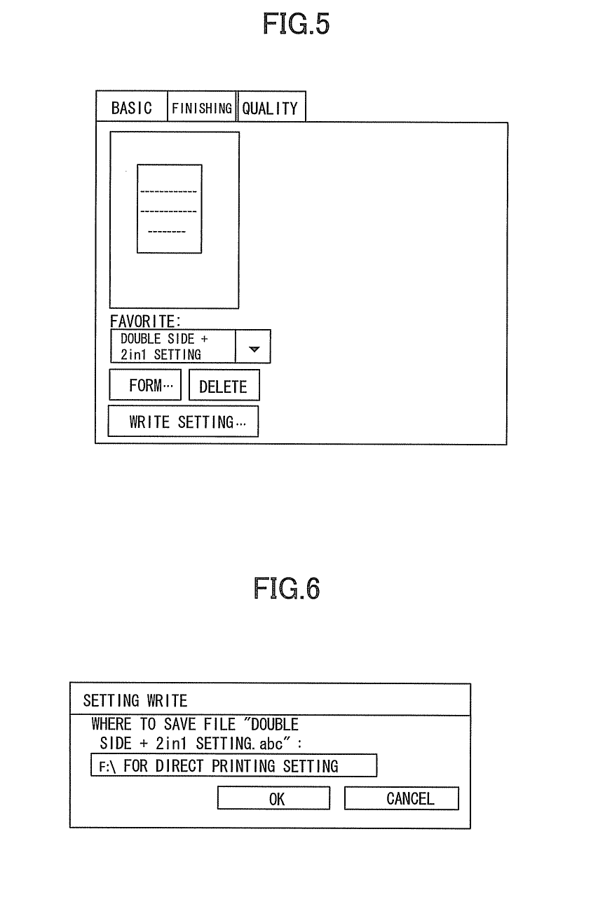

At Act 104, the PC controller 85A displays a setting check screen shown in FIG. 5 on the display screen 85B. The name of the print setting already set is displayed on the setting check screen. If a downward arrow displayed on the side of the name of the print setting is clicked, the list of selectable print settings is displayed. The list of the print settings may be set again by selecting “form” displayed on the display screen 85B. The list of the print settings may be erased by selecting “delete” displayed on the display screen 85B.

At Act 105, the PC controller 85A determines whether or not the instruction for “setting write” is given. If “write setting” displayed on the display screen 85B in FIG. 5 is selected, the PC controller 85A proceeds to Act 106.

At Act 106, the PC controller 85A displays a save screen shown in FIG. 6 on the display screen 85B. The save screen displays the name of the print setting and where the setting should be saved.

At Act 107, the PC controller 85A determines whether or not the instruction for the save is given. If “OK” is selected on the display screen 85B in FIG. 6, the PC controller 85A determines that the instruction for the save is given, and proceeds to Act 108. If “cancel” is selected, the PC controller 85A determines that the printing is stopped, and ends the flow.

At Act 108, the PC controller 85A stores the print settings in the portable memory 101 inserted on the PC memory insertion portion 85C and ends the flow.

The print data may be stored in the portable memory 101 before the print setting is performed, or may be stored in the portable memory 101 after the print setting.

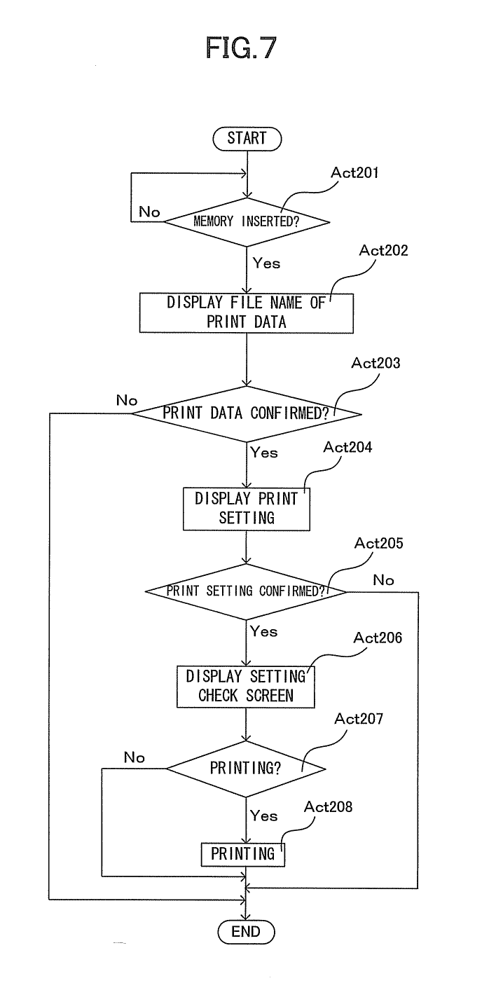

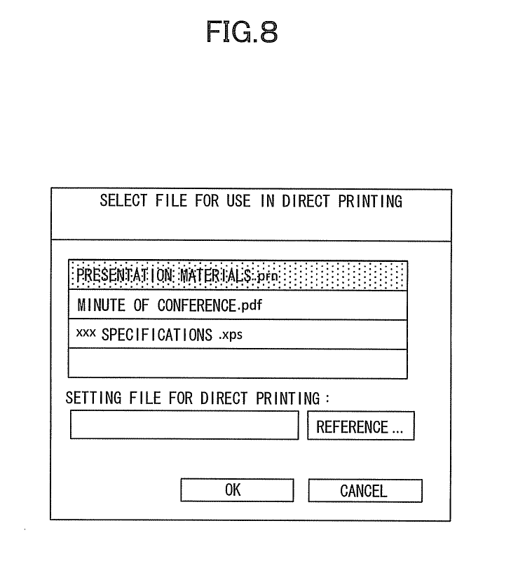

Next, a method of printing the print data will be described with reference to FIG. 7 to FIG. 10. FIG. 7 is a flow chart showing the method of printing the print data stored in the portable memory 101. FIG. 8 to FIG. 10 show display screens displayed in the operation display portion 805 in printing.

At Act 201, the controller 801 determines whether or not the portable memory 101 is inserted on the memory insertion portion 804. If the controller 801 determines at Act 201 that the portable memory 101 is inserted on the memory insertion portion 804, the controller 801 proceeds to Act 202.

At Act 202, the controller 801 displays the file name of print data stored in the portable memory 101 on the operation display portion 805. If a plurality of print data are present, the names of all of them are displayed on the operation display portion 805. The print data to be printed is selected by clicking the file name of that print data. In the operation display portion 805 shown in FIG. 8, the print data having the file name “presentation materials” shown with hatching is selected.

At Act 203, the controller 801 determines whether or not the print data is confirmed. If “OK” is selected in the operation display portion 805 shown in FIG. 8, the controller 801 determines that the print data is confirmed, and proceeds to Act 204. If “cancel” is selected, the controller 801 determines that the stop of printing is selected, and ends the flow.

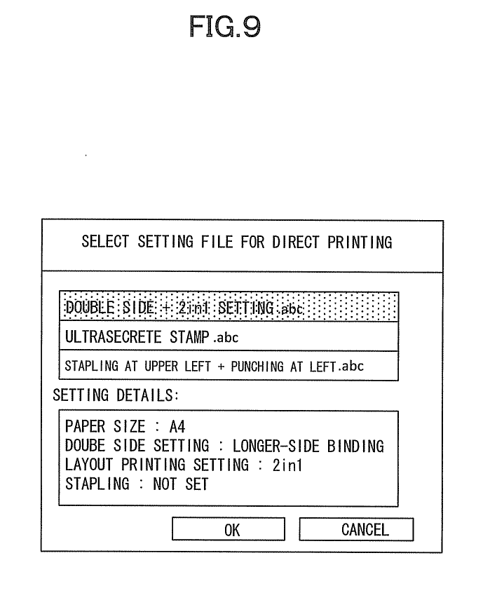

At Act 204, the controller 801 displays the file name of the print setting stored in the portable memory 101 on the operation display portion 805. If a plurality of print settings are present, the names of all of them are displayed in the operation display portion 805. The print setting is selected by clicking the file name of that print setting. In the operation display portion 805 shown in FIG. 9, the print setting having the file name “double side+2in1 setting” shown with hatching is selected. The details of the selected print setting are displayed in the operation display portion 805. In the operation display portion 805 shown in FIG. 9, “paper size,” “double side setting,” and “layout printing” are displayed as the details of the print setting, and “A4,” “longer-side binding”, and “2in1” are set, respectively.

At Act 205, the controller 801 determines whether or not the print setting is confirmed. If “OK” is selected in the operation display portion 805 shown in FIG. 9, the controller 801 determines that the print setting is confirmed, and proceeds to Act 206. If “cancel” is selected, the controller 801 determines that the stop of printing is selected, and ends the flow.

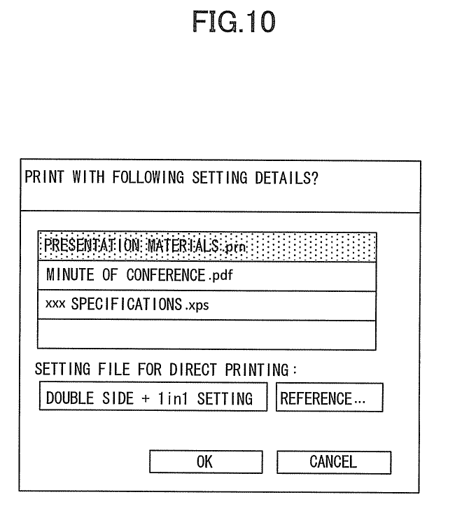

At Act 206, the controller 201 displays the folder name of the selected print data and the folder name of the print setting in the operation display portion 805. In the operation display portion in FIG. 10, the hatching shows that “presentation materials” is the selected print data, and the character information on the side of “reference” shows that “double side+2in1 setting” is the selected print setting.

At Act 207, the controller 801 determines whether or not the instruction for printing is given. If “OK” displayed in the operation display portion 805 in FIG. 10 is selected, the controller 801 determines that the instruction for printing is given. If “cancel” is selected, the controller 801 determines that the stop of printing is selected, and ends the flow.

Since the print setting information is previously established, detailed print setting does not need to be performed in the printer 1. This can suppress the exclusive use of the printer 1 over a prolonged period in performing the direct printing.

### (Modification)

Referring to FIG. 2, the print setting information may be saved in a storage portion of the server 80. The controller 801 may download the print setting information saved in the server 80 through the communication portion 807 and may print the print data stored in the portable memory 101 based on the downloaded print setting information.

Referring to FIG. 2, the print setting information may be saved in the internal memory 803. The controller 801 may execute the file of the print setting saved in the internal memory 803 and may print the print data stored in the portable memory 101.

The print setting may be updated in accordance with the frequency of use.

All of the names of the print settings and print data stored in the potable memory 101 may be displayed simultaneously in the operation display portion 805.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. A printer comprising:
an insertion portion is inserted a first memory stores print data; and
a controller which acquires preset print setting information and performs printing of the print data based on the print setting information.

2. The printer according to claim 1, wherein the first memory stores the print setting information.

3. The printer according to claim 1, further comprising a display portion,
wherein the controller outputs a first signal for displaying a name of the print data in the display portion and outputs a second signal for displaying a name of the print setting information in the display portion.

4. The printer according to claim 3, wherein the print data includes a plurality of print data, and
wherein the controller displays, in the display portion, a selection screen on which one of these print data is selected.

5. The printer according to claim 3, wherein the display portion is of a touch panel type.

6. The printer according to claim 1, wherein the print setting information includes at least one of information about stapling, hole punching, and Nin1.

7. The printer according to claim 1, wherein the first memory is a USB memory.

8. The printer according to claim 1, wherein the print setting information is stored in a second memory different from the first memory.

9. The printer according to claim 8, further comprising the second memory.

10. The printer according to claim 8, wherein the second memory is located in a server apparatus which communicates with the printer.

11. A printing control method comprising: reading print data from a first memory inserted on a printer; and performing printing of the print data based on preset print setting information.

12. The method according to claim 11, wherein the first memory stores the print setting information.

13. The method according to claim 11, further comprising displaying a name of the print data in a display portion of the printer and displaying a name of the print setting information in the display portion.

14. The method according to claim 13, wherein the print data includes a plurality of print data, and a selection screen on which one of these print data is selected is displayed in the display portion.

15. The method according to claim 13, wherein the display portion is of a touch panel type.

16. The method according to claim 11, wherein the print setting information includes at least one of information about stapling, hole punching, and Nin1.

17. The method according to claim 11, wherein the first memory is a USB memory.

18. The method according to claim 11, wherein the print setting information is stored in a second memory different from the first memory.

19. The method according to claim 18, wherein the printer includes the second memory.

20. The method according to claim 18, wherein the second memory is located in a server apparatus which communicates with the printer.
